(19) United States
(12) Patent Application Publication
(10) Pub. No.: US 2015/0270706 A1
(43) Pub. Date: Sep. 24, 2015

(54) OVER-VOLTAGE SUPPRESSION CIRCUIT

(71) Applicant: Parker-Hannifin Corporation, Cleveland, OH (US)

(72) Inventor: Peter C. Mehl, Fort Worth, TX (US)

(21) Appl. No.: 14/615,775

(22) Filed: Feb. 6, 2015

Related U.S. Application Data
(60) Provisional application No. 61/968,631, filed on Mar. 21, 2014.

(51) Int. Cl. H02H 9/04

(52) U.S. Cl. CPC H02H 9/04

(57) ABSTRACT

An overvoltage-suppression circuit includes voltage-suppression elements in series, each voltage-suppression element having at least one voltage-clamping device in parallel with at least one capacitor. An overvoltage-suppression module for protecting multiple lines includes a passive circuit element connected between a load line for each load and floating node common to all load lines. The module further includes a voltage-suppression element, having at least one voltage-clamping device in parallel with at least one capacitor, between the floating node and a ground. An overvoltage-suppression system includes a plurality of overvoltage-suppression modules. In one embodiment of the system, one input of a first overvoltage-suppression module is connected to one input of a second overvoltage-suppression module. In another embodiment of the system, one input of a first overvoltage-suppression module is connected to the floating node of a second overvoltage-suppression module.

### RELATED APPLICATION DATA

This application claims the priority of U.S. Provisional Application No. 61/968-361, filed on Mar. 21, 2014, which is hereby incorporated in its entirety by reference.

### TECHNICAL FIELD OF THE INVENTION

The present technology relates to overvoltage suppression and, more particularly, to circuits having voltage-clamping devices and capacitors, for both single-line and multi-line applications.

### BACKGROUND

Voltage surge protection is used in a wide variety of applications including consumer electronics, industrial processing, and extreme environment and specialized applications such as aerospace, nuclear, medical, and down-hole drilling. In particular, applications such as fuel cell stacks, battery stacks, and LED lighting provide a high voltage differential between ground and line voltage, yet a comparatively low voltage differential in line-to-line drop, especially in voltage monitoring conditions. These applications usually express a low line current, with any undesired voltage surges or lightning upsets occurring between the specific line and the ground.

Existing overvoltage circuit designs, such as the circuit depicted in FIG. 1, typically use, for each line, a single high voltage, high power TVS (Transient Voltage Suppression) device 2 connected in parallel with a single capacitor 4 between an input 6 and output 8. Other designs include series-stacked TVS diodes, and multiple TVS diodes tied to the same ground or electrical node. Disadvantages of the existing approaches include the size and quantity of high voltage, high power TVS devices, and the number of capacitors necessary to meet the voltage level. Further, existing approaches permit significant line voltage variation between the clamping voltage and the breakdown voltage of a high voltage TVS or a similar effective stack of TVS devices.

For applications requiring suppression of multiple lines, when the lines are referenced to that same electrical node TVS diodes are typically tied to the same ground or reference point. While typically a ground point, tying the TVS components to the ground node limits the amount of voltage variation between lines to the summation of the clamping voltage ratings of the TVS diodes. Using regulated nodes at high voltages is known to provide a local ground for a suppression circuit. While this can often be desirable, it requires additional components, additional power, and creates additional circuit noise. This type of design requires a modular approach when utilizing multiple voltage ranges and can become a very large circuit area with a substantial power draw.

### SUMMARY OF THE INVENTION

The present disclosure provides an overvoltage-suppression circuit. The circuit can include voltage-suppression elements in series, each element having at least one voltage-clamping device in parallel with at least one capacitor, to form a ladder of voltage-suppression elements. This ladder design minimizes use of non-essential components, minimizes component volume, and minimizes the circuit's effective time constant in high voltage applications for ground-to-line voltage where large line-to-line voltage variation is undesirable. The design is also modular, scalable, and stackable in several ways.

According to one aspect of the disclosure, an overvoltage-suppression circuit includes at least two voltage-suppression elements, each voltage-suppression element including an input, an output, at least one voltage-clamping device electrically connected between the input and the output, and at least one capacitor electrically connected in parallel to the at least one voltage-clamping device, wherein the output of a first voltage-suppression element of the at least two voltage-suppression elements is electrically connected to the input of a second voltage-suppression element of the at least two voltage-suppression elements to form a series connection.

According to an embodiment of the overvoltage-suppression circuit, the circuit includes at least one passive circuit element electrically connected in parallel to the at least two voltage-suppression elements.

According to another embodiment of the overvoltage-suppression, the at least one passive circuit element includes at least one capacitor.

According to a further embodiment of the overvoltage-suppression circuit, the at least one passive circuit element includes at least one voltage-clamping device.

According to one more embodiment of the overvoltage-suppression circuit, the at least one passive circuit element includes at least one additional voltage-suppression element.

According to an embodiment of the overvoltage-suppression circuit, the circuit includes at least one passive circuit element electrically connected in series to one of the input of the first voltage-suppression element or the output of the second voltage-suppression element.

According to another embodiment of the overvoltage-suppression circuit, the at least one passive circuit element includes at least one capacitor.

According to a further embodiment of the overvoltage-suppression circuit, the at least one passive circuit element includes at least one voltage-clamping device.

According to one more embodiment of the overvoltage-suppression circuit, the at least one passive circuit element includes at least two additional voltage-suppression elements electrically connected in parallel.

According to an embodiment of the overvoltage-suppression circuit, the at least one voltage-clamping device is one of a transient voltage suppressor or a non-linear resistor.

According to another embodiment of the overvoltage-suppression circuit, the non-linear resistor is a metal oxide varistor.

According to another aspect of the disclosure, an overvoltage-suppression module for protecting at least two load lines, wherein each load line includes an electrical connection between a load and a source, includes for each of the at least two load lines an input connectable to the load line, an output connectable to a ground, for each of the at least two load lines a passive circuit element electrically connected between a floating node shared by the at least two load lines and the input connectable to the load line, and a voltage-suppression element electrically connected between the output and the floating node, wherein the voltage-suppression element includes an input, an output, at least one voltage-clamping device electrically connected between the input and the output, and at least one capacitor electrically connected in parallel to the at least one voltage-clamping device.

According to an embodiment of the overvoltage-suppression module, the passive circuit element includes at least one capacitor.

According to another embodiment of the overvoltage-suppression module, the passive circuit element includes at least one voltage-clamping device.

According to a further embodiment of the overvoltage-suppression module, the passive circuit element includes at least one additional voltage-suppression element.

According to one more embodiment of the overvoltage-suppression module, a resistor is electrically connected between the respective source and respective load of at least one of the at least two load lines.

According to an embodiment of the overvoltage-suppression module, an overvoltage-suppression system includes a first overvoltage-suppression module and a second overvoltage-suppression module, wherein one input of the first overvoltage-suppression module is electrically connected to one input of the second overvoltage-suppression module.

According to a further embodiment of the overvoltage-suppression module, an overvoltage-suppression system includes a first overvoltage-suppression module, wherein the first overvoltage-suppression module further includes an additional input and an additional passive circuit element electrically connected between the floating node and the additional input, and a second overvoltage-suppression module, wherein the additional input of the first overvoltage-suppression module is electrically connected to the floating node of the second overvoltage-suppression module.

### BRIEF DESCRIPTION OF THE DRAWINGS

FIG. 1 is a circuit diagram of a conventional voltage-suppression element.

FIG. 2 is a schematic view of an exemplary overvoltage-suppression circuit comprising a ladder of voltage-suppression elements in accordance with the present disclosure.

FIG. 3 is a circuit diagram of an exemplary ladder of voltage-suppression elements in accordance with the present disclosure.

FIG. 4 is a schematic view of an exemplary overvoltage-suppression circuit comprising a ladder of voltage-suppression elements in parallel with a passive circuit element in accordance with the present disclosure.

FIG. 5 is a schematic view of an exemplary overvoltage-suppression circuit comprising a ladder of voltage-suppression elements in series with a passive circuit element in accordance with the present disclosure.

FIG. 6 is a schematic view of an exemplary overvoltage-suppression circuit comprising a ladder of voltage-suppression elements in series with an additional set of voltage-suppression elements in accordance with the present disclosure.

FIG. 7 is a schematic view of an exemplary overvoltage-suppression module for protection of multiple load lines in accordance with the present disclosure.

FIG. 8 is a circuit diagram of an exemplary overvoltage-suppression module for protection of multiple load lines in accordance with the present disclosure.

FIG. 9 is a schematic view of an exemplary overvoltage-suppression system for protection of multiple load lines using multiple overvoltage-suppression modules in accordance with the present disclosure.

FIG. 10 is a schematic view of another exemplary overvoltage-suppression system for protection of multiple load lines using multiple overvoltage-suppression modules in accordance with the present disclosure.

### DETAILED DESCRIPTION OF EMBODIMENTS

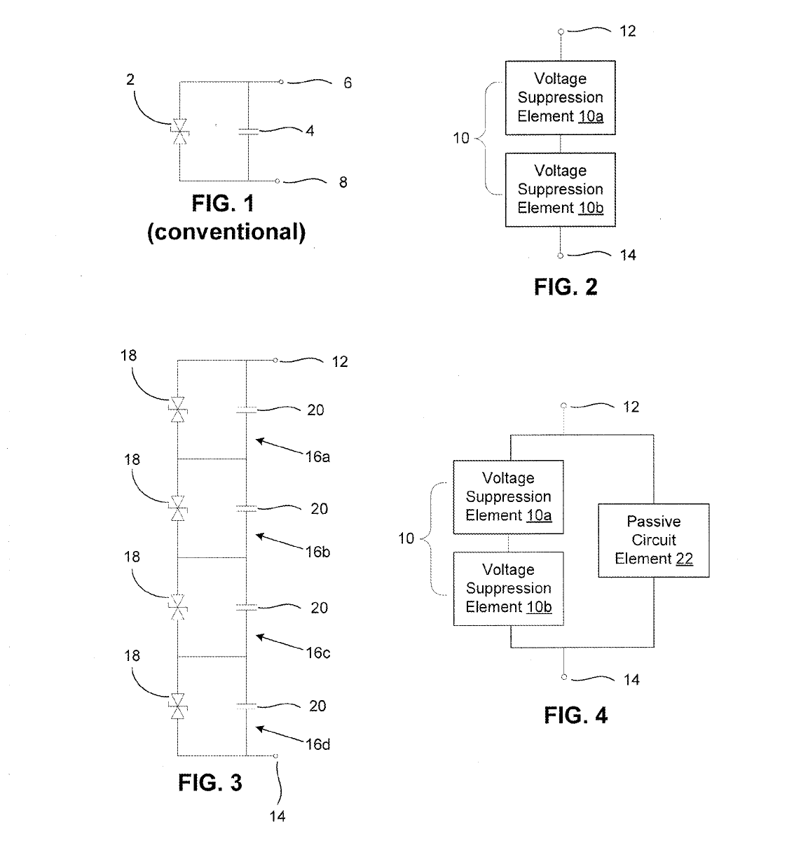

Referring now in detail to the drawings, and initially to FIG. 2, an exemplary overvoltage-suppression circuit includes at least two voltage-suppression elements 10a and 10b. Each voltage-suppression element 10a and 10b includes an input and output, at least one voltage-clamping device, such as a TVS, MOV or other voltage suppression device, electrically connected between the input and the output, and at least one capacitor electrically connected in parallel to the at least one voltage-clamping device. The output of the first voltage-suppression element 10a is electrically connected to the input of the second voltage-suppression element 10b to form a series connection between a circuit input 12 and a circuit output 14.

The above-described configuration, wherein two or more voltage-suppression elements are connected in series, each voltage-suppression element including at least one TVS device, MOV device, or other voltage suppression device in parallel with a capacitance, is referred to herein as a Suppression Device and Capacitor Ladder (“SD-Cap Ladder”). For example, voltage-suppression element 10a and 10b, together in series, are an SD-Cap Ladder 10. The simplistic voltage-suppression element of FIG. 1 could serve as one or more of the voltage-suppression elements in SD-Cap Ladder 10. Placing one or more voltage-clamping devices in parallel with set of capacitors clamps the maximum voltage the capacitors will see and thus minimizes the voltage requirements for the capacitors. Capacitors in parallel with TVS diodes will further minimize the voltage variation per time period of a given electrical node or voltage difference, and minimize the instantaneous power that the TVS diodes must dissipate. Thus, a greater comparative capacitance with looser tolerances can be placed in series without risk of overvoltage.

It should be appreciated that the characteristics and arrangement of components used will depend on the particular application for which the overvoltage-suppression circuit is being applied. For instance, voltage-clamping devices may include, but are not limited to TVS diodes and non-linear resistors such as varistors and, in particular, metal oxide varistors (MOVs). Voltage-clamping devices should be chosen with proper maximum reverse standoff voltages and clamping voltages, and to handle a sufficient peak power. Multiple TVS devices can be arranged to create higher values with lesser-rated components. Likewise, capacitors may have any suitable capacitance and tolerance necessary to help balance the circuit by absorbing voltage spikes and preventing voltage overshoot. Regardless of component characteristics, the overvoltage suppression circuit in accordance with the present disclosure can mitigate cost and circuit footprint by reducing the total number of components.

For example, conventional capacitance series stacking runs into tolerance issues since most capacitors have tolerances in the 5% to 20% range. Accordingly, given an unequal value distribution in a two-ladder element setup with 20% tolerance resistors, the maximum voltage applied for a nominally equal capacitance value can range from 40% to 60% of the maximum voltage applied across the load terminals (a nominal 1 μF capacitor with a ±20% variance gives: 0.8 μF/(0.8 μF+1.2 μF)=40% or 1.2 μF/(0.8 μF+1.2 μF)=60%, where each value is the percent of maximum voltage applied across the terminals.) A similar circuit, but integrated into an SD-Cap Ladder utilizing a TVS diode, has a maximum voltage, regardless of tolerance, of the TVS clamping voltage. Thus, a 0.5 μF ±20% effective capacitance can be created from two 1 μF ±20% capacitors that have voltage tolerance levels at a sufficient level above the TVS clamping voltage, but lower than 60% of the maximum applied line voltage while still considering worst case tolerance stack-up. Capacitors usually have stringent derating criteria per various military standards with regards to voltage. The SD-Cap Ladder design helps to meet those standards by requiring less voltage of a single capacitive element within the circuit. Other benefits include the reduced, but not eliminated, filtering capability of the total capacitance when a single capacitor goes “open.” In this case, the voltages for all other capacitors are still clamped to the appropriate voltage limits.

An SD-Cap Ladder may include any number of voltage-suppression elements in series. Each voltage-suppression element may include any number of voltage-clamping devices, in any possible configuration, in parallel with any number of capacitors, in any suitable configuration. For example, the voltage element 10a may have two MOVs in series with each other, the MOVs being in parallel with a set of three capacitors.

FIG. 3 illustrates another exemplary SD-Cap Ladder showing exemplary individual components. The SD-Cap Ladder of FIG. 3 includes an input 12 and output 14, and four voltage-suppression elements 16a-16d. Each voltage-suppression element 16a-16d includes one bidirectional TVS diode 18 in parallel with a capacitor 20.

Turning to FIG. 4, the overvoltage-suppression circuit may further include at least one passive circuit element, such as passive circuit element 22, electrically connected in parallel to the SD-Cap Ladder 10. Passive circuit elements may include any number of passive circuit devices, in any suitable configuration. Examples of passive circuit devices include, but are not limited to, voltage-clamping devices, capacitors and composite circuits such as the voltage suppression elements 10a and 10b described above.

In one embodiment, the parallel passive circuit element 22 includes at least one capacitor. If the passive circuit element 22 includes more than one capacitor, the capacitors may be arranged in series with each other, in parallel with each other, or in a configuration combining series and parallel capacitors. Additional parallel capacitance may help contain voltage overshoot across the SD-Cap Ladder.

In another embodiment, the parallel passive circuit element 22 includes at least one voltage-clamping device. If the passive circuit element 22 includes more than one voltage-clamping device, the voltage-clamping devices may be arranged in series with each other, in parallel with each other, or in a configuration combining series and parallel voltage-clamping devices. Parallel voltage-clamping devices may increase the power and current handling capabilities of the circuit by lessening the current through each device at overvoltage. Preferably, parallel clamping devices should have the same characteristics to prevent a device with a lower breakdown voltage from handling a disproportional amount of current.

In a further embodiment, the parallel passive circuit element 22 includes at least one additional voltage-suppression element. Additional voltage-suppression elements are of the same basic form as described above for voltage-suppression elements 10a and 10b. Additional voltage-suppression elements may differ in configuration from the voltage-suppression elements of the parallel SD-Cap Ladder 10. For example, additional voltage-suppression elements may differ in the number of voltage-clamping devices, number of capacitors, or the arrangement of the components. If more than one additional voltage-suppression element is used, then each additional voltage-suppression element may differ in configuration from each other additional voltage-suppression element. Moreover, if the passive circuit element 22 includes more than one additional voltage-suppression element, the additional voltage-suppression elements may be arranged in series with each other, in parallel with each other, or in a configuration combining series and parallel additional voltage-suppression elements.

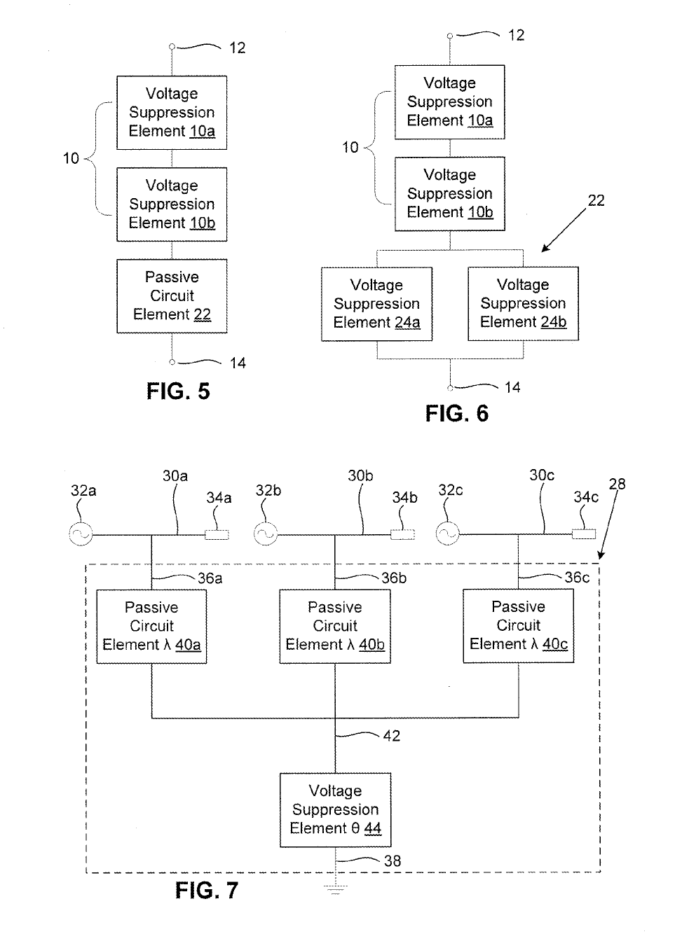

Referring now to FIG. 5, the overvoltage-suppression circuit may further include at least one passive circuit element, such as passive circuit element 22, electrically connected in series to one of the input 12 or the output 14 the SD-Cap Ladder 10. In one embodiment, the series passive circuit element 22 includes at least one capacitor. If the passive circuit element 22 includes more than one capacitor, the capacitors may be arranged in series with each other, in parallel with each other, or in a configuration combining series and parallel capacitors. Capacitors in series with the SD-Cap Ladder can help reduce the magnitude of a surge pulse.

In another embodiment, the series passive circuit element 22 includes one or more additional voltage-clamping devices in series with the SD-Cap Ladder. If the passive circuit element 22 includes more than one voltage-clamping device, the voltage-clamping devices may be arranged in series with each other, in parallel with each other, or in a configuration combining series and parallel voltage-clamping devices. Additional voltage-clamping devices in series may be used in higher-voltage applications to increase standoff voltage of the suppression circuit. Such a configuration may be desirable in applications where the working voltage is higher than that of a typical TVS device or the total standoff voltage of an SD-Cap Ladder. Adding one or more series-connected TVS devices may allow for increased standoff voltage at less cost and with more precision than adding additional ladders and/or capacitors.

In a further embodiment, shown in FIG. 6, the series passive circuit element 22 comprises at least two additional voltage-suppression elements, for example voltage-suppression elements 24a and 24b, electrically connected in parallel with respect to each other. The additional voltage-suppression elements 24a and 24b are of the same basic form as described above for voltage-suppression elements 10a and 10b. The additional voltage-suppression elements 24a and 24b may differ in specific configuration from the voltage-suppression elements 10a and 10b of the parallel SD-Cap Ladder 10. For example, the additional voltage-suppression elements 24a and 24b may differ in the number of voltage-clamping devices, number of capacitors, or the arrangement of components. Moreover, each additional voltage-suppression element 24a and 24b, and any further additional voltage-suppression elements included, may differ in configuration from each other additional voltage-suppression element. Further, if the passive circuit element 22 includes more than two additional voltage-suppression elements, the other additional voltage-suppression elements may be arranged in series with both or either of the additional voltage-suppression element 24a and 24b, in parallel with them, or in any configuration combining series and parallel additional voltage-suppression elements. It should be noted, however, that an additional set of series-connected voltage-suppression elements, connected in turn in series with the SD-Cap Ladder 10, would essentially extend the length of the SD-Cap Ladder 10.

The SD-Cap Ladder and its many variations, some of which were described above, are suitable for overvoltage-suppression of a single load line. A similar approach, however, may be utilized in applications that require protection of a plurality of load lines. Fuel cells, battery packs, and LED lighting are exemplary applications that could benefit from a modular SD-Cap Ladder design. In these applications particularly, the voltage differential between an individual measurement point and its corresponding neighbors is quite small, but the common mode voltage may be very high. A modular design approach can then be performed for groups of measurement points wherein a similar voltage difference can be discerned.

Turning now to FIG. 7, illustrated is an exemplary overvoltage-suppression module 28 having a tree-like topology, for protecting at least two load lines, for example load lines 30a-30c. Each load line 30a-30c includes an electrical connection between a respective source 32a-32c and respective load 34a-34c. Although the exemplary sources 32a-32c are shown as AC sources, the module 28 may also serve to protect DC sources. The loads 34a-34c may be any electrical load. For each load line 30a-30c, the module 28 is connectable via inputs 36a-36c to a point on the respective load line 30a-30c. The module 28 is also connectable to a ground or chassis through an output 38. For each load line 30a-30c, a respective passive circuit element 40a-40c is electrically connected between a floating node 42, shared by the load lines 30a-30c, and the respective input 36a-36c connectable to each respective load line 30a-30c. The module 28 further includes a voltage-suppression element 44 electrically connected between the output 38 and the floating node 42. The voltage-suppression element 44 includes an input, an output, at least one voltage-clamping device electrically connected between the input and the output, and at least one capacitor electrically connected in parallel to the at least one voltage-clamping device.

Each passive circuit element 40a-40c may include at least one capacitor. If more then one capacitor is used, the capacitors may be arranged in series or parallel so as to achieve a desired total capacitance. Alternatively, a passive circuit element 40a-40c may include at least one voltage-clamping device, such as a TVS diode or MOV. If more then one voltage-clamping device is used, the voltage-clamping devices may be arranged in series or parallel so as to achieve a desired clamping characteristic. The passive circuit elements 40a-40c may further include a voltage-suppression element, such as voltage-suppression elements 10a and 10b described earlier, the passive circuit elements 40a-40c having at least one voltage-clamping device in parallel with at least one capacitor.

Set out below are exemplary specifications of components for a voltage-suppression, such as module 28. While the module need not adhere to these specifications, doing so will provide a relatively stable voltage in reference to ground and near to the respective line voltages.

For a set of load lines 1 to N, passive circuit elements λ₁ to λ_{N}, such as passive circuit elements 40a-40c, may be said to have an effective capacitances C_{EFF}(λ₁) to C_{EFF}(λ_{N}), effective maximum clamping voltages V_{C}(λ₁) to V_{C}(λ_{N}), maximum reverse standoff voltages V_{R}(λ₁) to V_{R}(λ_{N}), and peak power dissipations P(λ₁) to P(λ_{N}). A voltage-suppression element θ, such as voltage-suppression element 44, can be said to have effective capacitance C_{EFF}(θ), effective maximum clamping voltage V_{C}(θ), maximum reverse standoff voltage V_{R}(θ), and peak power dissipation P(θ). The maximum required working voltage for each load line U₁(θ, λ₁) to U₁(θ, λ_{N}) can then be calculated as U_{A}(θ, λ_{A})=V_{R}(λ_{A})+V_{R}(θ), where A is the specific line number.

While components with any suitable characteristics may used in the present design, in order to minimize power and size requirements on passive circuit elements λ₁ to λ_{N}, V_{R}(θ) should be chosen such that voltages V_{R}(λ₁) to V_{R}(λ_{N}) are minimized, but such that the maximum required working voltages for each load line are met and that V_{R}(λ₁) to V_{R}(λ_{N}) are all greater than zero volts. Also, to allow for proper voltage monitoring, for each specific line A, the magnitude of the difference between maximum working voltage U_{A}(θ, λ_{A}) and the nominal voltage at a common floating node, such as floating node 42, should be much less than the maximum reverse standoff voltages V_{R}(λ_{A}) for that line. Exactly how much less will differ in each application. The same applies to the magnitude of the difference between the minimum working voltage W_{A}(θ, λ_{A}) and the nominal voltage at the common floating node 42. It should be noted that the nominal voltage at the common floating node may vary somewhat over time. The voltage change at the common floating node can be calculated by adding the initial voltage to a constant found by integrating the current through the capacitor over time and dividing by C_{EFF}(θ). Further, for any two specific lines X and Y having minimum required working voltages W_{X}(θ, λ_{X}) and W_{Y}(θ,λ_{Y}), it should hold true that U_{X}(θ, λ_{X}) −W_{Y}(θ, λ_{Y}) ≦V_{R}(λ_{X}) to V_{R}(λ_{X}).

The effective capacitance C_{EFF}(θ) of voltage-suppression element θ should be greater than each one of the individual line capacitances C_{EFF}(λ₁) to C_{EFF}(λ_{N}). If the module is to be used in an application where simultaneous overvoltage on all lines is expected, such as a cable bundle test, then C_{EFF}(θ) should be greater than the combined sum of all the individual lines C_{EFF}(λ₁) to C_{EFF}(λ_{N}).

P(θ) and P(λ₁) to P(λ_{N}) should be chosen to handle the peak power dissipation of each load line, but only after determining C_{EFF}(θ) and C_{EFF}(λ₁) to C_{EFF}(λ_{N}). Typically, P(θ) should be grater than any of P(λ₁) to P(λ_{N}), but applications and design criteria exist where this expectation does not apply. If all lines are to receive simultaneous overvoltage, then P(θ) should be sized to handle the combination of overvoltages.

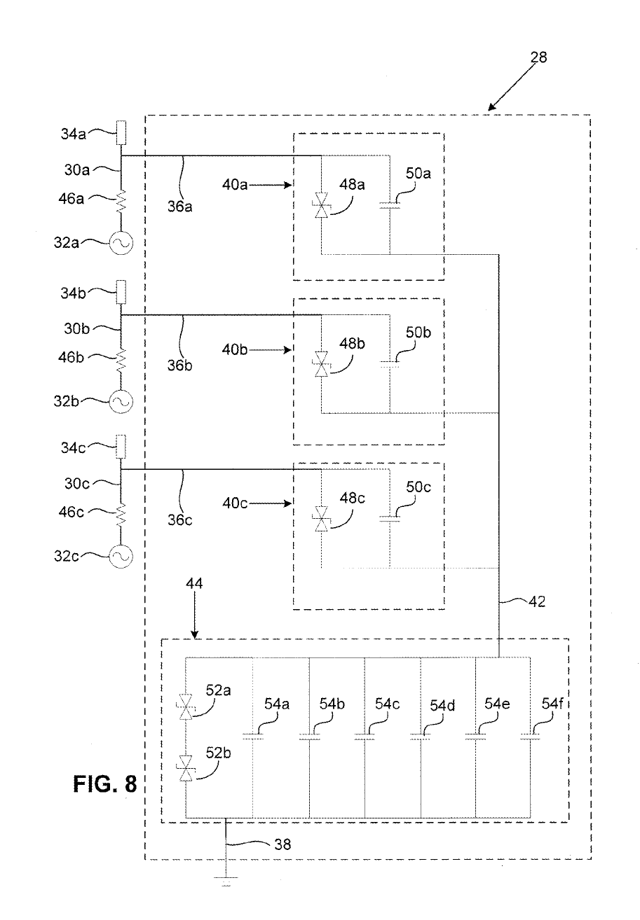

Turning briefly to FIG. 8, illustrated is a circuit diagram of exemplary overvoltage protection module 28. The module 28 is electrically connected to three load lines 30a-30c, each having a respective sources 32a-32c and respective loads 34a-34c. Each load line 30a-30c may include a respective in-line resistor 46a-46c electrically connected between the respective source 32a-32c and respective load 34a-34c of the respective load line 30a-30c. If the resistor 46a-46c is connected between the respective source 32a-32c and respective input 36a-36c of the overvoltage-suppression module 28, then the module 28 will serve to protect the respective source 32a-32c. If the resistor 46a-46c is connected between the respective load 34a-34c and respective input 36a-36c of the overvoltage-suppression module 28, then the module 28 will serve to protect the respective load 34a-34c.

In exemplary module 28, each passive circuit element 40a-40c includes a respective bidirectional TVS diode 48a-48c in parallel with a respective capacitor 50a-50c. Thus, each passive circuit element 40a-40c in exemplary module 28 is similar to the elementary voltage-suppression element described earlier. Each passive circuit element 40a-40c is in turn electrically connected to the common floating node 42. Between the floating node 42 and the output 38 of the module 28 is the voltage-suppression element 44. In this embodiment, the voltage-suppression element 44 includes two series-connected bidirectional TVS diodes 52a and 52b. The TVS diodes 52a and 52b are electrically connected in parallel with an effective capacitance created by the set of parallel capacitors 54a-54f. The output 38 of the module 28 is electrically connected to ground.

Using the above-described exemplary design, voltage overshoot at the floating node 42 is contained by the effective capacitance of capacitors 54a-54f and dissipated by TVS diodes stack 52a and 52b. The voltage at the floating node 42 is nominally much closer to the load lines than the output 38 connected to ground. The TVS diodes 48a-48c provide individual and direct paths from respective load lines 30a-30c to the floating node 42. Capacitors 50a-50c modify any voltage overshoot between the floating node 42 and the particular load line 30a-30c. The entire module keeps each load line pair within a set maximum clamped voltage of each other.

An overvoltage-suppression module, such as module 28 illustrated in FIGS. 7 and 8, may be used as a standalone component or grouped with other similar modules in order to protect more load lines. The module or modules may be constructed on one or more printed circuit or printed wire boards. When designing for similar line-to-line voltage levels but at different common mode voltages, passive circuit elements λ₁ to λ_{N}may be chosen such that only V_{C}(θ) and V_{R}(θ) change with the common mode voltage. This potentially mitigates printed circuit board module layout redesign for different common mode voltages if the particular component package footprint has sufficient variety in voltages.

As the number of lines to be protected increases, it may be desirable to utilize a plurality of overvoltage-suppression modules, in any of the above described or other configurations, rather than using a single overvoltage-suppression module. Optimum module size is a function of two competing parameters: the maximum expected working voltage difference line-to-line across the module, and the number of signal lines provided for by a single stabilized common node. As more lines are served by a single module, the part area efficiency increases (i.e., the circuit's physical footprint decreases), but greater the line-to-line voltage variability may exist.

If multiple modules are used, the modules need not be connected in any way other than by a common connection to a ground or chassis. It is also possible, however, to interleave multiple modules through additional connections between each module. As will be made clearer through examples below, a system of interleaved modules may be less component-efficient, as each module will require an extra passive circuit element λ for the connection. An interleaved design, however, may reduce line-to-line voltage surges that may occur between modules. Sets of stand-alone or interleaved modules may be grouped together to form a single overvoltage protection system that may be built on a printed circuit board.

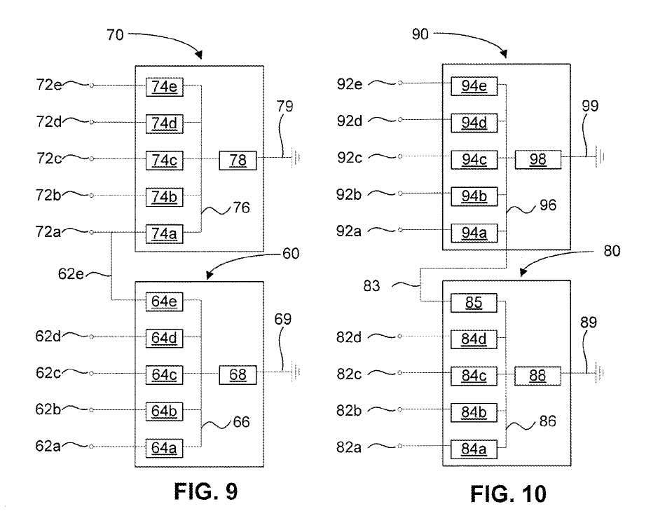

FIG. 9 shows an exemplary overvoltage-suppression system using one interleaved design. The system includes first and second overvoltage-suppression modules 60 and 70. Similar to the module designs described above, overvoltage-suppression module 60 includes inputs 62a-62e and passive circuit elements 64a-64e, each passive circuit element 64a-64e being connected between a respective input 62a-62e and a floating node 66. A voltage-suppression element 68 is connected between the floating node 66 and output 69, the out output 69 being in turn connected to ground. Likewise, overvoltage-suppression module 70 includes inputs 72a-72e and passive circuit elements 74a-74e, each passive circuit element 74a-74e being connected between a respective input 72a-72e and a floating node 76. A voltage-suppression element 78 is connected between the floating node 76 and output 79, the output 79 being in turn connected to ground. The interleaving in the exemplary configuration of FIG. 9 occurs by electrically connecting one input 62e of the first overvoltage-suppression module 60 to one input 72a of the second overvoltage-suppression module 70. Thus, the overvoltage-suppression modules 60 and 70 share the load line connected to inputs 62e and 72a and, accordingly, passive circuit elements 64e and 74a are connected to the same load line but to different floating nodes. If a third module were added, one input of the third module could be electrically connected input 72e, and so on for as many modules as desired. In order minimize any difference in line-to-line voltage reaction rates, the effective capacitance of passive circuit elements sharing a load line, such as passive circuit elements 64e and 74a, should be half that of passive circuit elements connected to only one load line, such as passive circuit elements 64a-64d and 74b-74e.

FIG. 10 displays another exemplary overvoltage-suppression system using a different interleaved design. The system includes first and second overvoltage-suppression modules 80 and 90. Similar to the module designs described above, overvoltage-suppression module 80 includes inputs 82a-82d and passive circuit elements 84a-84d, each passive circuit element 84a-84d being connected between a respective input 82a-82d and a floating node 86. The first overvoltage-suppression module 80 further includes an additional input 83, as well as a passive circuit element 85 connected between input 83 and the floating node 86. A voltage-suppression element 88 is connected between the floating node 86 and output 89, the output 89 being in turn connected to ground. Likewise, overvoltage-suppression module 90 includes inputs 92a-92e and passive circuit elements 94a-94e, each passive circuit element 94a-94e being connected between a respective input 92a-92e and a floating node 96. A voltage-suppression element 98 is connected between the floating node 96 and output 99, the out output 99 being in turn connected to ground.

The interleaving in the exemplary configuration of FIG. 10 occurs by electrically connecting additional input 83 of the first overvoltage-suppression module 80 to the floating node 96 of the second overvoltage-suppression module 90. Thus, unlike each other input 82a-82d of the first overvoltage-suppression module 80, input 83 is not connected to a load line. Rather, the floating node 86 of the first overvoltage-suppression module 80 and the floating node 96 of the second overvoltage-suppression module 90 are electrically connected through additional input 83 and additional passive circuit element 85. It may be desirable to modify the design of passive circuit element 85 from the other passive circuit elements to more efficiently handle voltage transients between the floating nodes 86 and 96 of each module. If a third module were added, the floating node of the third module could be electrically connected an input of the second overvoltage-suppression module 90, for example input 92e. In that case, the floating node of the third overvoltage-suppression module and the floating node 96 of the second overvoltage-suppression module 90 would be electrically connected through passive circuit element 94e. This connective pattern may repeat for as many modules as desired.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. An overvoltage-suppression circuit comprising:
at least two voltage-suppression elements, each voltage-suppression element including
an input,
an output,
at least one voltage-clamping device electrically connected between the input and the output, and
at least one capacitor electrically connected in parallel to the at least one voltage-clamping device,
wherein the output of a first voltage-suppression element of the at least two voltage-suppression elements is electrically connected to the input of a second voltage-suppression element of the at least two voltage-suppression elements to form a series connection.

2. The overvoltage-suppression circuit of claim 1, the circuit further comprising at least one passive circuit element electrically connected in parallel to the at least two voltage-suppression elements.

3. The overvoltage-suppression circuit of claim 2, wherein the at least one passive circuit element comprises at least one capacitor.

4. The overvoltage-suppression circuit of claim 2, wherein the at least one passive circuit element comprises at least one voltage-clamping device.

5. The overvoltage-suppression circuit of claim 2, wherein the at least one passive circuit element comprises at least one additional voltage-suppression element.

6. The overvoltage-suppression circuit of claim 1, the circuit further comprising at least one passive circuit element electrically connected in series to one of the input of the first voltage-suppression element or the output of the second voltage-suppression element.

7. The overvoltage-suppression circuit of claim 6, wherein the at least one passive circuit element comprises at least one capacitor.

8. The overvoltage-suppression circuit of claim 6, wherein the at least one passive circuit element comprises at least one voltage-clamping device.

9. The overvoltage-suppression circuit claim 6, wherein the at least one passive circuit element comprises at least two additional voltage-suppression elements electrically connected in parallel.

10. The overvoltage-suppression circuit according to claim 1, wherein the at least one voltage-clamping device is one of a transient voltage suppressor or a non-linear resistor.

11. The overvoltage-suppression circuit of claim 10, wherein the non-linear resistor comprises a metal oxide varistor.

12. An overvoltage-suppression module for protecting at least two load lines, wherein each load line includes an electrical connection between a load and a source, the module comprising:
for each of the at least two load lines, an input connectable to the load line;
an output connectable to a ground;
for each of the at least two load lines, a passive circuit element electrically connected between a floating node shared by the at least two load lines and the input connectable to the load line; and
a voltage-suppression element electrically connected between the output and the floating node, wherein the voltage-suppression element includes
an input,
an output,
at least one voltage-clamping device electrically connected between the input and the output, and
at least one capacitor electrically connected in parallel to the at least one voltage-clamping device.

13. The overvoltage-suppression module of claim 12, wherein the passive circuit element comprises at least one capacitor.

14. The overvoltage-suppression module of claim 12, wherein the passive circuit element comprises at least one voltage-clamping device.

15. The overvoltage-suppression module of claim 12, wherein the passive circuit element comprises at least one additional voltage-suppression element.

16. The overvoltage-suppression module of claim 12, wherein a resistor is electrically connected between the respective source and respective load of at least one of the at least two load lines.

17. An overvoltage-suppression system comprising:
a first overvoltage-suppression module according to claim 12; and
a second overvoltage-suppression module according to claim 12,
wherein one input the first overvoltage-suppression module is electrically connected to one input of the second overvoltage-suppression module.

18. An overvoltage-suppression system comprising:
a first overvoltage-suppression module according to claim 12, wherein the first overvoltage-suppression module further comprises an additional input and an additional passive circuit element electrically connected between the floating node and the additional input; and
a second overvoltage-suppression module according to claim 12,
wherein the additional input of the first overvoltage-suppression module is electrically connected to the floating node of the second overvoltage-suppression module.
